(19) United States
(12) Patent Application Publication
(10) Pub. No.: US 2002/0196943 A1
(43) Pub. Date: Dec. 26, 2002

(54) Telephone network and method for utilizing the same

(75) Inventors: David Carroll Challener, Raleigh, NC (US); Jeffrey W. Clark, Cary, NC (US); Peter Alexander Manson, Cary, NC (US); Joseph Patrick McGovern, Holly Springs, NC (US); Douglas Morgan Trent, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 09/892,376

(22) Filed: Jun. 26, 2001

(51) Int. Cl. H04L 9/00

(52) U.S. Cl. 380/266

(57) ABSTRACT

A telephone network and a method and system for its use is disclosed. In a first aspect of the present invention, a telephone network is disclosed. The telephone network includes an internet service provider (ISP) coupled to a local switching exchange. The local switching exchange receives and transmits calls to a plurality of devices. The network includes a plurality of modems coupled to the ISP. The network also includes a plurality of phone systems. Each of the phone systems including a cordless unit and a base station. Each of the plurality of phone systems also is associated with one of the plurality of modems, wherein a call can be routed to or from each of the cordless units through any of the modems to any of the plurality of devices. In a second aspect, a method and system for sending a call from a phone system to a device is disclosed. The phone system comprises a cordless unit and a base station. The phone system is also coupled to a modem. The modem is coupled to an internet service provider (ISP). The method and system comprises utilizing the cordless unit to initiate the call and determining whether the cordless unit is within range of the base station. The method and system further includes routing the call from the cordless unit to the ISP via the modem, if the cordless unit is within range of the base station and routing the call from the cordless unit to the ISP via another modem if the cordless unit is not within range of the base station. The another modem is associated with another base station and is coupled to the ISP. The method and system finally includes providing the call to the device.

### FIELD OF INVENTION

The present invention relates generally to telephony and more specifically to a method and system for utilizing cordless telephones to send and receive data over a public network such as the Internet.

### BACKGROUND OF THE INVENTION

Many different types of systems have provided city-wide two-way communications, such as radio systems for taxis or the police. In these systems, a single antenna is located near the center of the city. Each two-way conversation occupies one channel so if there were 100 channels in the city, only 100 simultaneous conversations could be held. To cover the entire city, the antenna is placed on a tall building and emits a very strong signal.

Cellular Phone Systems

However, in a typical cellular phone system, a city is divided into smaller sections, or cells. Each cell includes a base station and its own antenna and uses only a subset of all the channels. Each antenna is lower in height and emits a much weaker signal so that the same subset of channels can be used in a cell somewhere else within the city. For example, within a typical cellular system, every seventh cell uses the same set of channels.

When using the cellular phone, the phone needs to use the “closest” base station because that's the one with the strongest signal and the one that will give the best connection. To find the closest base station, the phone checks all of the control channels and determines which has the strongest signal. The cell phone chooses the strongest signal and decides to use that one for placing the call. The cell phone can travel from cell to cell by simply switching antennas.

Although cellular phone systems provide a convenient method of telecommunication, it is an extremely expensive way to communicate. Cellular phone users not only have to pay for outgoing calls, they must also pay for incoming calls as well.

What is needed is a method and system that has the convenience of a cellular phone system without the expense. The method and system should be simple, cost effective and capable of being easily adapted with existing technology. The present invention addresses such a need.

### SUMMARY OF THE INVENTION

A telephone network and a method and system for its use is disclosed. In a first aspect of the present invention, a telephone network is disclosed. The telephone network includes an internet service provider (ISP) coupled to a local switching exchange. The local switching exchange receives and transmits calls to a plurality of devices. The network includes a plurality of modems coupled to the ISP. The network also includes a plurality of phone systems. Each of the phone systems including a cordless unit and a base station. Each of the plurality of phone systems also is associated with one of the plurality of modems, wherein a call can be routed to or from each of the cordless units through any of the modems to any of the plurality of devices.

In a second aspect, a method and system for sending a call from a phone system to a device is disclosed. The phone system comprises a cordless unit and a base station. The phone system is also coupled to a modem. The modem is coupled to an internet service provider (ISP). The method and system comprises utilizing the cordless unit to initiate the call and determining whether the cordless unit is within range of the base station. The method and system further includes routing the call from the cordless unit to the ISP via the modem, if the cordless unit is within range of the base station and routing the call from the cordless unit to the ISP via another modem if the cordless unit is not within range of the base station. The another modem is associated with another base station and is coupled to the ISP. The method and system finally includes providing the call to the device.

In a third aspect, a method and system for receiving a call from a device by a phone system is disclosed. The device received a call from the phone system. The phone system includes a cordless unit and a base station. The phone system is coupled to a modem. The modem is coupled to an internet service provider (ISP). The method and system comprises providing the call to the ISP and determining whether the cordless unit being called is within range of the base station by the ISP. The method and system includes routing the data from the device to the cordless unit via the modem, if the cordless unit is within range of the base station; and routing the data from the device to the cordless unit via another modem if the cordless unit is not within range of the base station. The another modem is associated with another base station and is coupled to the ISP. Finally, the method and system includes the step of receiving the call by the phone system.

Through the use of the method and system in accordance with the present invention, Internet telephony is utilized in conjunction with cordless phone systems in order to facilitate two-way radio communication between a cordless unit and multiple base stations thereby creating a cellular-like telephone environment without the use of cellular telephones.

### BRIEF DESCRIPTION OF THE DRAWINGS

FIG. 1 is an example of an environment in which the method and system in accordance with the present invention may be used.

FIG. 2 is a flowchart of an embodiment of the method in accordance with the present invention.

FIG. 3 is a flowchart of an alternate embodiment of the method in accordance with the present invention.

FIG. 4 is a flowchart 400 of an outside device placing a call to the cordless unit in another embodiment of the method in accordance with the present invention.

### DETAILED DESCRIPTION OF THE INVENTION

The present invention provides a method and system for sending and receiving data over a public network. The following description is presented to enable one of ordinary skill in the art to make and use the invention and is provided in the context of a patent application and its requirements. Although the present invention has been described in the context of being used with the Internet, one of ordinary skill in the art will readily recognize that the present system can be used in conjunction with any type of networking system while remaining within the spirit and scope of the present invention. Accordingly, various modifications to the preferred embodiment will be readily apparent to those skilled in the art and the generic principles herein may be applied to other embodiments. Thus, the present invention is not intended to be limited to the embodiments shown but is to be accorded the widest scope consistent with the principles and features described herein.

The present invention provides a method and system for sending and receiving data over a public network such as the Internet. Through the use of the method and system in accordance with the present invention, Internet telephony is utilized in conjunction with cordless phone systems in order to facilitate two-way radio communication between a cordless unit and multiple base stations thereby creating a cellular-like telephone environment without the use of cellular telephones.

Internet Telephony

Although originally intended for the transmission of computer data, more recently the Internet has been exploited to provide real time telephony communications. A standard telephone connected to a Public Switching Telephone Network (PSTN) can communicate with any other PSTN connected telephone using a computer network such as the Internet as the transmission facility instead of conventional telephone transmission facilities.

The primary attraction of the Internet for telephony communications is the low charge compared with conventional (cellular) telephony. Many Internet users have a dial-up connection to an access provider over a local telephone line, and therefore such users pay only local telephone charges when logged on. Some Internet Service Providers (ISPs) charge a monthly description, whilst others charge on the basis of connection time (some may do both). However, there is generally no charge associated with actual data transfer over the network. As a result, the effective cost of an international call over the Internet may be no more than that of a local call of the same duration to the access provider. In addition, the fully digital nature of the Internet may potentially offer a richer functionality (e.g. in terms of conference calling) than conventional telephone networks.

The transmission of voice signals over a packet network involves a first computer digitally sampling a voice input signal at a regular rate (eg 8 kHz). A number of samples are then assembled into a data packet for transmission over the network to a second terminal, which then feeds the samples to a loudspeaker or equivalent device for playout, again at a constant 8 kHz rate. Voice transmission over the Internet is substantially similar to transmission over a LAN (which may indeed provide part of the Internet transmission path), but there tends to be less spare bandwidth available on the Internet. As a result, Internet phones normally compress the voice signal at the transmitting end, and then decompress it at the receiving end.

Cordless Phone Systems

Cordless telephone systems generally comprise a base station directly connected to the telephone line and handset units which are cordless and portable and associated with the base station through two-way radio communication. Today's cordless telephone systems have a range of about 1 mile meaning that a user can take the wireless handset up to a mile away from the base station before losing the radio signal. Taking this into consideration, Internet telephony can be utilized in conjunction with cordless phone systems in order to facilitate two-way radio communication between a cordless unit and multiple base stations thereby creating a cellular-like telephone environment without the use of cellular telephones.

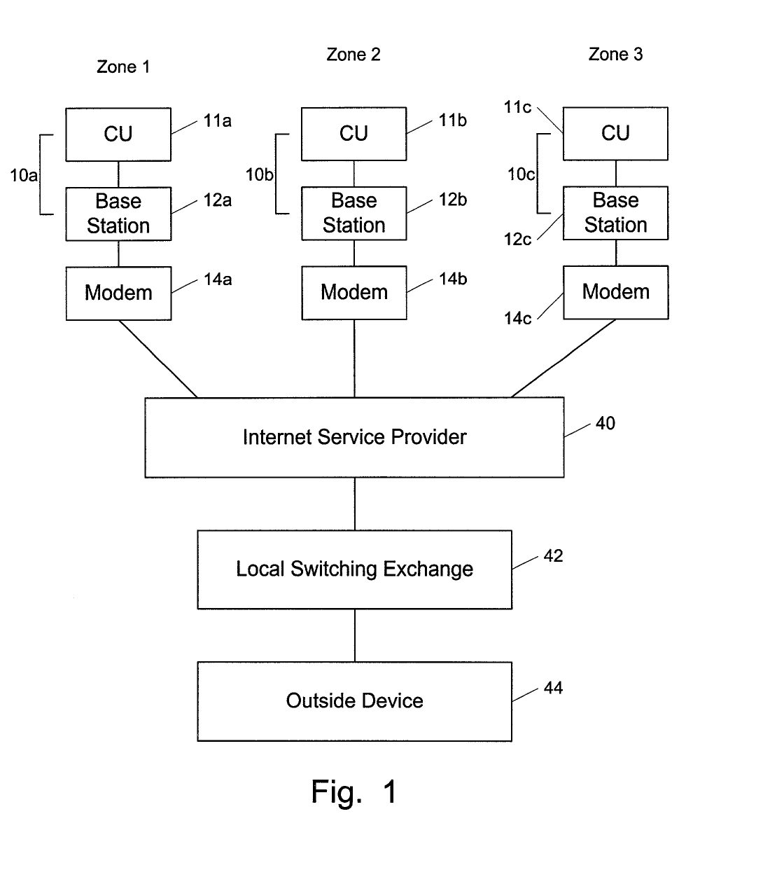

FIG. 1 illustrates a telephone network system in accordance with the present invention. The system includes a plurality of phone systems 10a-10c. Each of the phone systems 10a-10c comprises a cordless unit 11 and a base station 12. The base station 12 is coupled to an associated modem 14 wherein the modem 14 is coupled to an internet service provider (ISP) 40. The modem in a preferred embodiment is a cable modem. The ISP 40 in turn is coupled to a local switching exchange 42. The local switching exchange is coupled to an outside device 44. As is well understood by one of ordinary skill in the art, any number of outside devices 14 can be coupled to the local switching exchange and the devices can communicate with the local switching exchange 42..

A caller utilizes the cordless unit 11 to dial the number of an access port of the ISP 40 and the ISP 40 transmits the number of the outside device 44 when connected to the port. The port receives the number of the outside device 44 and establishes a two-way, full duplex communication link via the ISP 40 to a corresponding remote access port or specialized computer system in the vicinity of the outside device 44. The port at the receiving end is connected to the local switching exchange 42 in the region of the outside device 44 and uses the local switching exchange 42 to connect the call to the outside device 44. The communication protocols used by the computers on the Internet to communicate information include TCP (Transmission Control Protocol) and UDP (User Datagram Protocol). Both the TCP and UDP protocols are built on top of a lower layer protocol known as the IP (Internet Protocol). IP is used to format and route TCP and UDP messages.

In the system there are multiple zones, Zone 1, Zone 2, and Zone 3. One of ordinary skill in the art readily recognizes that there could be any number of zones and that they would be within the spirit and scope of the present invention. Zone 1 represents the coverage area of base station 12a, Zone 2 represents the coverage area of base station 12b, and Zone 3 represents the coverage area of base station 12c. In accordance with the present invention, if a communication link between the cordless unit 11a and the outside device 44 is established and the cordless unit 11a travels outside the coverage area of the base station 12a, another base station is utilized to maintain the communication link between the cordless unit 11a and the outside device 44. For example, if the cordless unit 11a travels from Zone 1 to Zone 2, the communication link is maintained by switching the cordless unit 11a from base station 12a to base station 12b. This is what is known in the telecommunications industry as a “handoff”.

It should be noted that in order to maintain privacy, the cordless unit 11 includes means for encrypting any data sent via the Internet. Various means for encrypting data that is sent over the Internet are known to those of ordinary skill in the art. For example, asymmetric and symmetric digital encryption techniques could be utilized in conjunction with the present invention. It should also be understood that what is meant by a call is providing either a voice message or a data message or any combination thereof over a telephone network.

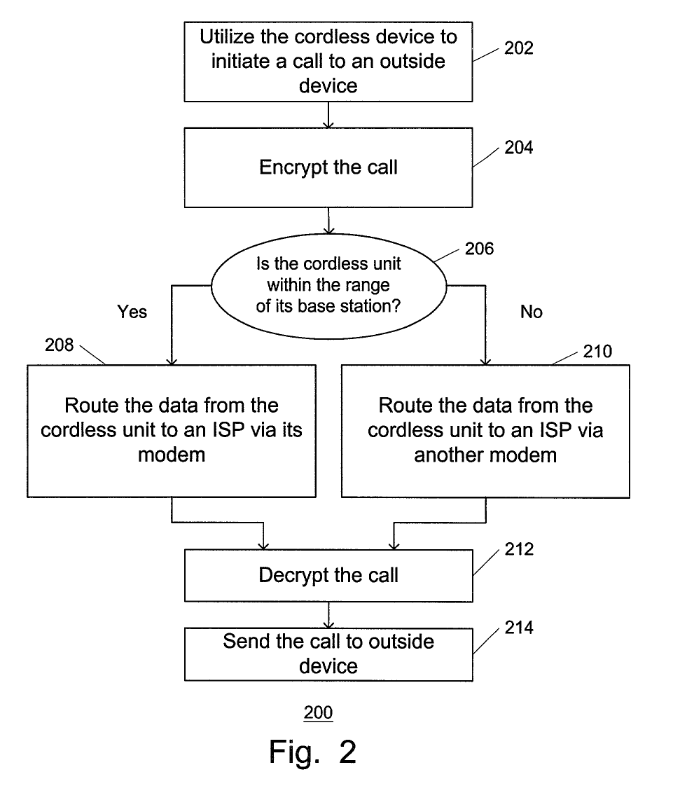

To better understand the method in accordance with the present invention, please refer now to FIG. 2. FIG. 2 is a flowchart 200 of sending a call from a cordless unit in accordance with the present invention. Referring now to FIGS. 1 and 2 together, first a cordless unit 11a initiates a call to an outside device 44, via step 202. The outgoing call is then encrypted, via step 204. This step preferably takes place within the cordless unit 11a and comprises converting the call from analog to digital and then utilizing an encryption technique to encrypt the digital data. In addition, the encrypted data preferably includes identification information related to the cordless unit. This is important for example if the ISP wants to charge a fee for allowing the cordless unit to operate in a “cellular” mode.

Next, it is determined whether the cordless unit 11a is within range of its base station 12a, via step 206. If the cordless unit 11a is within range of its base station 12a, the call is routed to the ISP 40 via modem 14a via step 208. This step preferably comprises utilizing the modem to convert the encrypted digital data to IP packets. Alternatively, if the cordless unit is not within range of the associated base station, the data is routed from the cordless unit to the ISP via a different modem (for a base station combination, for example, base station 12b and modem 14b), via step 210.

The call is then decrypted by the ISP 40, via step 212. This step preferably comprises utilizing the ISP to decrypt the IP packets, convert the IP packets to digital data and convert the digital data to analog data. Finally, the call is sent to the outside device, via step 214.

It should be noted that although the above-described invention is described in terms of the cordless unit sending calls or transmissions to the outside device 44, one of ordinary skill in the art will readily recognize that the present invention can also be utilized to allow a cordless unit to receive calls or transmissions from the outside device 44 during the call while remaining within the spirit and scope of the present invention.

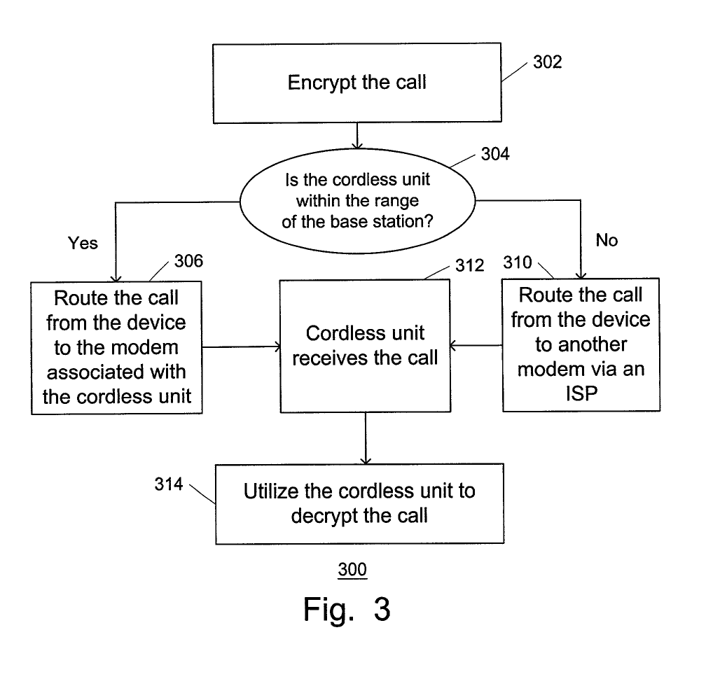

FIG. 3 is a flow chart 300 of the cordless unit 11a receiving transmissions in accordance with the present invention. First, the call by the outside device 44 is encrypted at the ISP 40, via step 302. This step preferably comprises utilizing the ISP 40 to convert the analog data to digital data, encrypt the digital data and convert the encrypted digital data to IP packets. Next, it is determined whether the cordless unit 11a is within range of its base station 12a via step 304.

The call is routed from a device to the cordless unit 11a via the modem 14a if the cordless unit 11a is within range of its base station 12a, via step 330. This step further comprises utilizing the modem to convert the IP packets to encrypted digital data. Alternatively, if the cordless unit 11a is not within range of the base station 12a, the call is routed from the ISP to the cordless unit 11a via another modem, via step 340. Preferably, that modem comprises a modem associated with another phone system, wherein the another phone system comprises a base station within range of the cordless unit. Finally, the data is decrypted by the cordless unit, via step 350. This step preferably comprises decrypting the digital data and converting the data from digital to analog. In so doing, the cordless unit and the device can communicate as long as there is a connection therebetween.

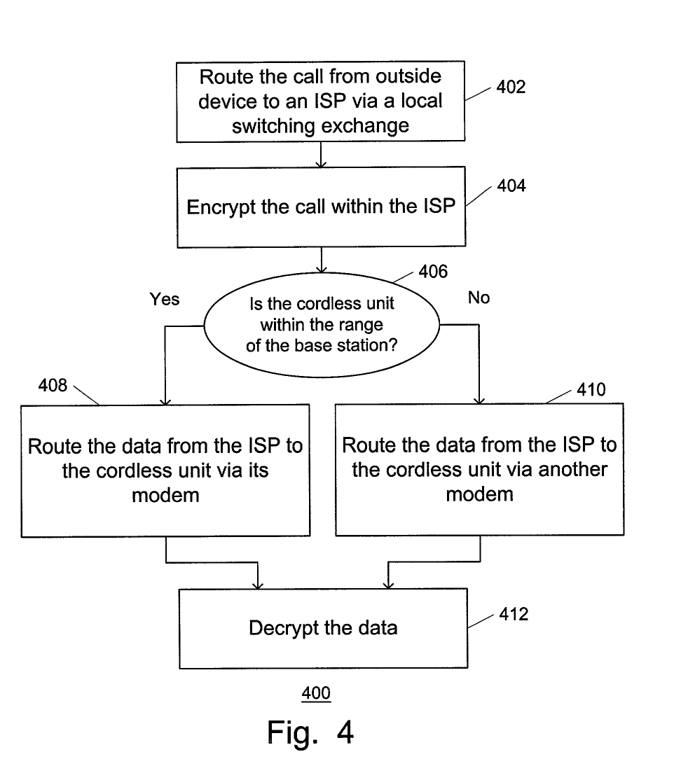

In addition, the above-described methodology can be utilized to allow an outside device to initiate a call to a cordless phone system. For an example of such an implementation, please refer to FIG. 4. FIG. 4 is a flowchart 400 of an outside device placing a call to the cordless unit in another embodiment of the method in accordance with the present invention. The call from the outside device to cordless unit 11a is routed to the ISP via the local switching exchange 44, via step 402. Next, the data is encrypted within the ISP, via step 404. This step preferably comprises utilizing the ISP to convert the analog data to digital data, encrypt the digital data and convert the encrypted digital data to IP packets. Next, it is determined whether the called cordless unit 11a is within range of its base station 12a, via step 406.

Data is routed from the ISP to the cordless unit 11a via modem 14a, if the cordless unit 11a is within range of the base station 12a, via step 408. This step further comprises utilizing the modem to convert the IP packets to encrypted digital data. Alternatively, if the cordless unit 11a is not within range of the base station 12a, the data is routed from the ISP 40 to the cordless unit 11a via another modem (for example, modem 14b, via step 410. Finally, the data is decrypted within the cordless unit 11a, via step 414. This step preferably takes place within the cordless unit and comprises decrypting the digital data and converting the data from digital to analog.

The above-described invention provides a method and system for providing telephone calls over a public network such as the Internet. One of ordinary skill in the art readily recognizes that a call could be voice messages or data messages carried out over the telephone and they would be within the spirit and scope of the present invention. Through the use of the method and system in accordance with the present invention, Internet telephony is utilized to facilitate two-way radio communication between a cordless unit and multiple base stations thereby creating a cellular-like telephone environment without the use of cellular telephones.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of appended claims.

What is claimed is:

1. A telephone network comprising:
an internet service provider (ISP) coupled to a local switching exchange; the local switching exchange for receiving and transmitting calls to a plurality of devices;
a plurality of modems coupled to the ISP; and
a plurality of phone systems, each of the phone systems including a cordless unit and a base station; each of the plurality of phone systems being associated with one of the plurality of modems, wherein a call can be routed to or from each of the cordless units through any of the modems to any of the plurality of devices.

2. The telephone network of claim 1 wherein a call is routed from a cordless unit to the ISP if the cordless unit is within range of its associated base station, and the call is routed from another of the plurality of modems if the cordless unit is within range of the base station associated with the another modem.

3. The telephone network of claim 1 wherein a call is encrypted by a cordless unit and decrypted by the ISP.

4. The telephone network of claim 3 wherein each of the plurality of modems can convert an encrypted call to IP packets.

5. The telephone network of claim 3 wherein the encrypted call includes information related to the phone system which initiates the call.

6. The telephone network of claim 4 wherein the ISP decrypts the IP packets and converts the IP packets to analog data for delivery to a device

7. The telephone network of claim 4 wherein each of the plurality of modems comprise a cable modem.

8. A method for sending a call from a phone system to a device, the phone system comprising a cordless unit and a base station, the phone system being coupled to a modem, the modem being coupled to an internet service provider (ISP), the method comprising the steps of:
(a) utilizing the cordless unit to initiate the call;
(b) determining whether the cordless unit is within range of the base station;
(c) routing the call from the cordless unit to the ISP via the modem, if the cordless unit is within range of the base station;
(d) routing the call from the cordless unit to the ISP via another modem if the cordless unit is not within range of the base station, the another modem being associated with another base station and being coupled to the ISP; and
(e) providing the call to the device.

9. The method of claim 8 that includes the step of (a1) encrypting the call prior to step (b).

10. The method of claim 9 wherein encrypting step (a1) further comprises:
(ai) utilizing the cordless unit to convert the data from analog to digital and
(aii) utilizing an encryption technique within the cordless unit to encrypt the digital data.

11. The method of claim 10 wherein the encrypted digital data comprises information related to the phone system.

12. The method of claim 11 wherein the modem routing step (c) further comprises the step of (c1) utilizing the modem to convert the encrypted digital data to IP packets.

13. The method of claim 12 wherein the another modem routing step (d) further comprises the step of (d1) utilizing the another modem to convert the encrypted digital data to IP packets.

14. The method of claim 13 wherein the providing step (e) includes the step of (e1) decrypting the data by the ISP.

15. The method of claim 14 wherein the encrypting step (e1) further comprises the steps of:
(e1i) decrypting the IP packets;
(e1ii) converting the IP packets to digital data; and
(e1iii) converting the digital data to analog data.

16. A method for receiving a call from a device by a phone system, the device having been called from the phone system, the phone system comprising a cordless unit and a base station, the phone system being coupled to a modem, the modem being coupled to an internet service provider (ISP), the method comprising the steps of:
(a) providing the call to the ISP;
(b) determining whether the cordless unit being called is within range of the base station by the ISP;
(c) routing the data from the device to the cordless unit via the modem, if the cordless unit is within range of the base station; and
(d) routing the data from the device to the cordless unit via another modem if the cordless unit is not within range of the base station the another modem being associated with another base station and being coupled to the ISP; and
(e) receiving the call by the phone system.

17. The method of claim 16 that wherein the providing step (a) includes the step of (a1) encrypting the call.

18. The method of claim 17 wherein encrypting step (a1) further comprises:
(ai) utilizing the ISP to convert the data from analog to digital and
(aii) utilizing an encryption technique within the ISP to encrypt the digital data.

19. The method of claim 18 wherein the encrypted digital data comprises information related to the phone system.

20. The method of claim 19 wherein modem routing step (c)) further comprises the step of (c1), utilizing the modem to convert the encrypted digital data to IP packets.

21. The method of claim 20 wherein the another modem routing step (d) further comprises the step of (d1), utilizing the another modem to convert the encrypted digital data to IP packets.

22. The method of claim 13 wherein the provided step includes the step of (e1), decrypting the data by the cordless unit.

23. The method of claim 14 wherein the encrypting step (e1) further comprises the steps of:
(e1i) decrypting the IP packets;
(e1ii) converting the IP packets to digital data; and
(e1iii) converting the digital data to analog data.

24. A phone system comprising:
a base station, the base station being coupled to a modem, wherein the modem is coupled to an internet service provider (ISP); and
a cordless unit, the cordless unit being associated with the base station, wherein a call can be routed to or from the cordless unit through the modem or through another modem coupled to the ISP if the cordless unit is within range of a base station that is associated with the another modem.

25. The phone system of claim 24 wherein the call is encrypted by the cordless unit.

26. The phone system of claim 25 wherein the encrypted call includes information related to the phone system.

27. The phone system of claim 24 wherein the modem and the another modem each comprises a cable modem.
